(19) United States
(12) Patent Application Publication
(10) Pub. No.: US 2023/0237163 A1
(43) Pub. Date: Jul. 27, 2023

(54) Secured Numeric and/or AlphaNumeric Method of Entry

(71) Applicant: Amjad Rahhal, Lake Forest, CA (US)

(72) Inventor: Amjad Rahhal, Lake Forest, CA (US)

(73) Assignees: Amjad Rahhal, Aliso Viejo, CA (US); Nour Rahhal, Aliso Viejo, CA (US)

(21) Appl. No.: 17/581,864

(22) Filed: Jan. 22, 2022

(51) Int. Cl. G06F 21/60

(52) U.S. Cl. CPC G06F 21/60

(57) ABSTRACT

Method and system of secure access. In one exemplary embodiment, an application, computer, electronic, system, and/or processor implemented method of a secure access gateway to a destination include the step of receive it a request remotely or locally to access a destination or a system. The method of authentication establishes a connection to a destination on behalf of the remote or local user. The invention can be directed to any secured field/cell that requires secured entry of confidential or secured data consisting of any numeric or alphanumeric characters. Examples for this are: password/passcode entry for payment, login to secured app, bank transactions, bank card details, payment credentials, network devices credentials entry, Pin entries at payment devices ... etc.

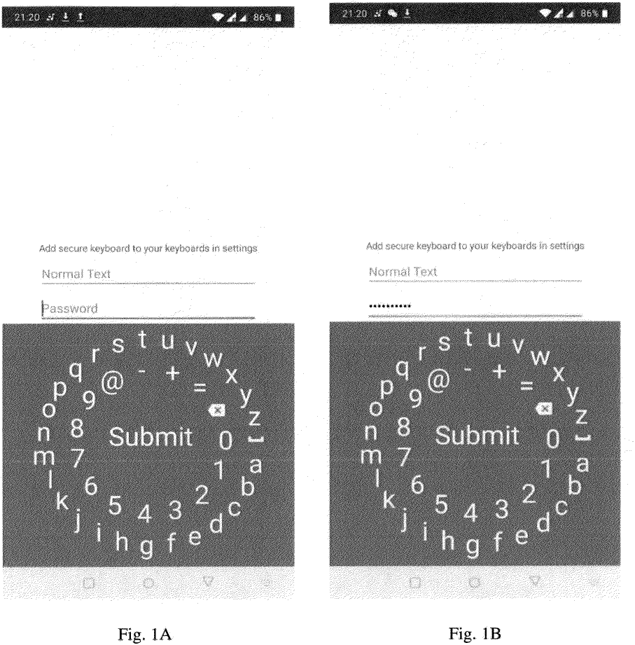

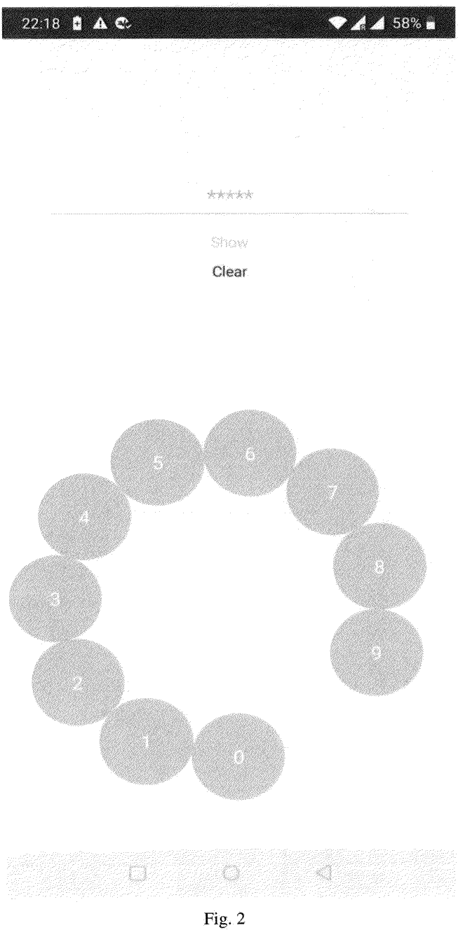

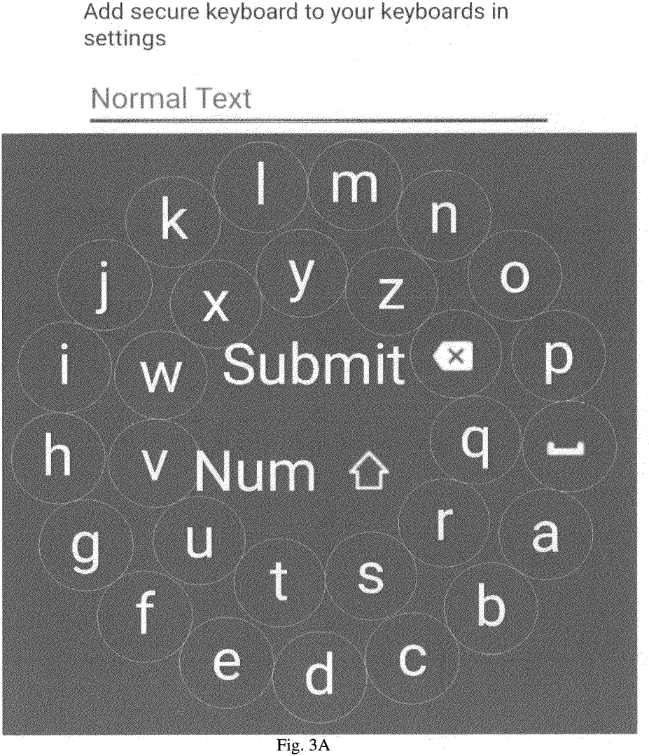

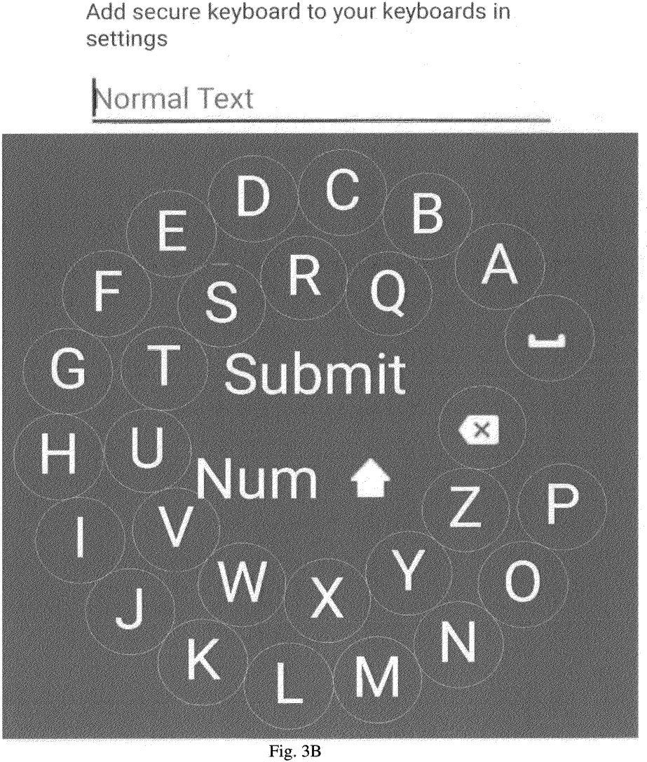

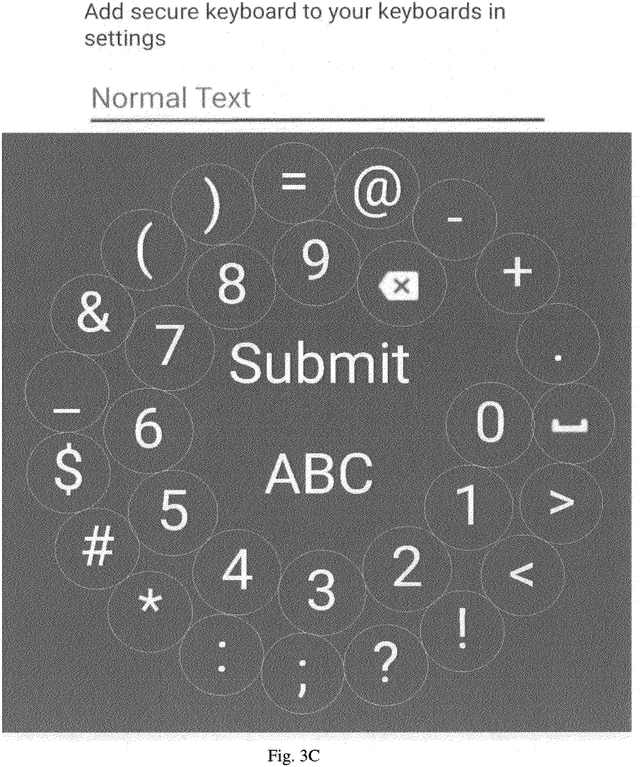

### FIELD OF THE INVENTION

A secured method of entry such as but not limited to a password or any secured data entry when requested by the user or the interface via calling a secured interaction user interface linked to a local control panel or cloud platform. This is established through but not limited to a virtual method of entry where Numerics and/or AlphaNumeric characters are displayed in a two or more circulars, cyclical or similar forms or objects. The Numeric/AlphaNumeric keys are displayed at the circumstance or borders of the object or form shape with multiple rounds (two or more).
The object or form updates (for example: rotates, generates, regenerates) in randomized or specific pattern resulting in a physical arrangement of the key(s) whenever a key is selected.
EXAMPLE: A User is requested to enter a form of identification (for example: password/passcode) via an object or form (example: virtual keyboard) where numeric or alphanumeric characters are displayed in a pattern (for example: circumference, circular shape).
EXAMPLE: The method of entry can be a virtual keyboard, object or form and may have multiple parallel planes. For instant, the object or form (ex: circular or other shaped keyboard) may have initial characters, pattern, or form, of which another pattern or shape is presented within it at a shorter radius or sized characters or numbers. The focus point, axis, radius and rotation may randomly be assigned at every selection of a numeric or character.
EXAMPLE: The present invention can be directed to any secured field/cell that requires secured entry of confidential or secured data consisting of any numeric or alphanumeric characters. Examples for this are: password/passcode entry for payment, login to secured app, bank transactions, bank card details, payment credentials, network devices credentials entery, Pin enteries at payment devices ..etc

### DESCRIPTION OF THE RELATED ART

Descriptions of specific devices, techniques, and applications are provided only as examples. Various modifications to the examples described herein may be readily apparent to those of ordinary skill in the art, and the general principles defined herein may be applied to other examples and applications without departing from the spirit and scope of the various embodiments
The characters can be numeric 0-9, alpha, or non-alpha special characters. They can be mapped in but not limited to a random or specific pattern or shape and located within the shape/pattern which may have various layers. Whenever a character is selected the pattern, shape, or object would update (for example: regenerate pattern, random rotation around its center or axis) changing the physical location of the characters.
The user may select alphanumeric visual images or interface and an internal secured algorithm processes the final output as a result of each end user selection based on the selected internal locations and not on the actually mapped alphanumeric of the operating system method of entry.
The existing mapped characters at the method of entry returned by the operating system are mapped to the correct characters matching the character images at the shape or object based on secured algorithm and mathematical equations. The resulted string or form of identification matches the intended user password or secured data.
The form of identification is optionally encrypted and sent to the calling program or system based on the User stored certificates (public key)
Different options are available to upload the user certificates (public key), which can be stored at the client device or stored at a cloud vault. The public keg may also be injected or pushed by the calling program or system.
The alphanumeric method of entry may have different security watermarks that are randomly or specifically generated at every session and the underlying algorithm and mathematical equations calculate the selected characters accordingly
The developer of the equation may not predict the selected characters as they may be based on the random watermarks generated and used during the form of identification entry session
Keyboard logging or sniffing can be meaningless as it won’t be able to figure out the correct selected characters until they are calculated
Calculation and mapping of selected locations may occur inside the application or software, or the selected locations may be sent to the cloud platform where calculation can be performed in order to establish a higher level of security

### SUMMARY

Use cases are unlimited for any form of secured data entry. The functionality is not limited to authentication. Below include but are not limited to some examples of usages:
A method or system for payment identification entry for a system login
Identification method of entry to authenticate any secured transaction
Identification method of entry at an EFT or payment device
Bank or payment cards details
Credentials entry at network devices

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Below include but and are not limited to some example drawings for visualization of usages:

• FIG. The virtual keyboard characters 0 to 9 are displayed in, but not limited to, rounded shape, like a circle or hexagonal or any rounded shape, instead of the traditional square or rectangular shape

• The characters are always displayed in sequence so as not to confuse the User and make it easy and seamless to find the required character, so that the characters are not shuffled or scattered.

• Sequence characters are shaped as images of buttons that are displayed on the circumstance or the borders of the main shape of the keyboard

• The starting location of the sequence is random at each session and the radius of the radius of the keyboard circle is also random

• Optionally, the keyboard shape keeps rotating randomly at each selection or each click

### DETAILED DESCRIPTION

The following descriptions can be utilized to implement certain example embodiments; however, other embodiments are not limited in this context
The application or software can, but is not limited to, run as a method of entry in the operating system or SDK called by the calling program
The user reaches a secured entry field where a method of identification can be required, the secured method of identification (example: password keyboard) can be selected as an input method to secure the entry of the method of identification or (for example: alphanumeric password).
The application or software can perform calculations algorithmically for the sequence characters of the method of entry and display them in an arrangement in sequence as alphanumeric selections.
The alphanumeric selections can be images that may not map one-to-one to the underlying operating system method of entry keys mapped password
For example, the first key, can be defined as character “A” or “a” and may be displayed at a random point on the main boundary of the method of entry. The succeeding alphanumeric keys sequence can follow in specific order or in sequence.
The user may select different character set while protecting the same arrangement
Every selection can show a key or sign in the method of identification field. The operating system will return the underlying method of entry which may not be the character selected by the user.
When the user completes entering all characters of their method of identification such as but not limited to a password, the underlying algorithm can calculate and map the operating system returning characters to the actual characters mapped in the alphanumeric images and accordingly returns the correct string entered by the user.
Optionally and depending on the application or software configuration, the user may request to send the alphanumeric password encrypted by the uploaded public key of the user’s digital certificate
When encryption is selected, the entered entry string is encrypted, and the encrypted string can return back to the calling system
The user can have multiple options for uploading certificate, this includes but not limited to storing it in the device or in the vault at the cloud platform
If the entry string is encrypted then the user system may decrypt the retuned string using the private key of the user’s digital certificate. Different encryption methods may or may not be provided for selection by the user.
The user may have options to load different skins for the images of the keyboard
The licensing can depend on the options that the user selects. Examples of those include but not limited to: Plain, Encrypted, Cloud or local store of the certificate, default or other skins ..etc
The SDK version will allow the user system to use the application or software with more flexibility and calculation of the selected locations would realize the correct clicked images without the need to map them to the key grids that are mapped to the operating system

1. A secured method of entry such as but not limited to a password or any secured data entry when requested by the user or the interface via calling a secured interaction user interface linked to a local control panel or cloud platform.

2. The virtual keyboard characters (numeric 0-9, alpha, or non-alpha special characters) are displayed, but not limited to, in one or parallel rounded shapes, like a circle or hexagonal or any rounded shape, instead of the traditional square or rectangular shape. The Numeric/Alphanumeric keys are displayed at the circumstance or borders of the object or form a shape with multiple parallel rounds. Characters are shaped as images of buttons that are displayed on the circumstance or the borders of the main shape of the keyboard using an unpredictable self-changing algorithm.

3. The characters are always displayed in sequence so as not to confuse the User and make it easy and seamless to find the required character, so that the characters are not shuffled or scattered, though the positions are always random.

4. The position and starting location of the sequence is random at each session and the radius of the radius of the keyboard circle is also random at every session.

5. Optionally, the keyboard shape keeps rotating randomly at each selection or each click. Keys positions are randomly allocated and may not be re-generated.
